(19) United States
(12) Patent Application Publication
(10) Pub. No.: US 2005/0069707 A1
(43) Pub. Date: Mar. 31, 2005

(54) Soft magnetic particles methods of making and articles formed therefrom

(75) Inventors: Steven Tysoe, Ballston Spa, NY (US); Robert Zabala, Schenectady, NY (US); Luana Iorio, Clifton Park, NY (US); Amitabh Verma, Bangalore (IN)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 10/672,623

(22) Filed: Sep. 26, 2003

(51) Int. Cl. B32B 5/16; B05D 7/00

(52) U.S. Cl. 428/403; 427/213; 427/220

(57) ABSTRACT

A soft magnetic particle having an elongated first portion and a second portion disposed on the first portion in an amount from about 0.05 weight percent to about 1 weight percent is provided. The first portion is formed of a soft magnetic material. The second portion is formed of an electrically insulating material.

### BACKGROUND OF INVENTION

The present disclosure relates to soft magnetic particles. More particularly, the present disclosure relates to soft magnetic particles, methods of making such particles, and electromagnetic devices formed therefrom.

Magnetic materials fall generally into two categories: hard magnetic materials and soft magnetic materials. Hard magnetic materials are materials that can be permanently magnetized, such as hardened steel. Conversely, soft magnetic materials are materials that can be reversibly magnetized, such as iron.

Soft magnetic materials find use in a variety of electromagnetic devices, such as, stators, rotors, solenoids, transformer cores, inductors, actuators, MRI pole faces, MRI shims, sensors, electronic circuits, and others. For example, motors typically contain a stack of thin sheets of soft magnetic material (e.g., stator or rotor). The sheets within the stack are often insulated from one another to prevent eddy current from circulating between the sheets.

Unfortunately, the multiple steps required to punch and then stack each lamination is a time consuming and costly process. In addition, a large amount of scrap material is generated during the aforementioned punching steps.

There is a continuing desire for more efficient electromechanical devices, namely devices that overcome one or more of the aforementioned efficiency and other deleterious effects of prior devices. As such, there is a continuing desire for new soft magnetic materials, methods of making such materials, and electromagnetic articles formed from such materials.

### BRIEF DESCRIPTION OF THE INVENTION

A soft magnetic particle is provided. The particle includes an elongated first portion and a second portion disposed on the first portion in an amount from about 0.05 weight percent to about 1 weight percent. The first portion is formed of a soft magnetic material. The second portion is formed of an electrically insulating material.

Further, a method of applying a coating to a plurality of elongated soft magnetic particles is provided. The method includes separating the plurality of elongated soft magnetic particles from one another with a first gas flow so that the coating can be applied to the plurality of elongated soft magnetic particles when separated; fluidizing the plurality of elongated soft magnetic particles with a second gas flow so that a third gas flow can urge the plurality of elongated soft magnetic particles back into said first gas flow; and applying a fourth gas flow to the fluidized plurality of elongated soft magnetic particles.

A composite magnetic article is also provided. The article includes a plurality of soft magnetic particles compacted to a selected density. Each of the soft magnetic particles has an elongated first portion coated with an insulating second portion such that the composite magnetic article has a core loss of less than about 6 Watts per pound at a magnetic flux density of about 1 Tesla and a frequency of about 60 Hertz.

### BRIEF DESCRIPTION OF THE DRAWINGS

FIG. 1 is an exploded, perspective view of exemplary electromagnetic devices;

FIG. 2 is a perspective view of a first exemplary embodiment of a soft magnetic particle;

FIG. 3 is a perspective view of a second exemplary embodiment of a soft magnetic particle;

FIG. 4 is a block diagram of an exemplary embodiment of a process of forming a soft magnetic particle; and

FIG. 5 is a block diagram of an exemplary embodiment of a process of forming a soft magnetic particle.

### DETAILED DESCRIPTION OF THE INVENTION

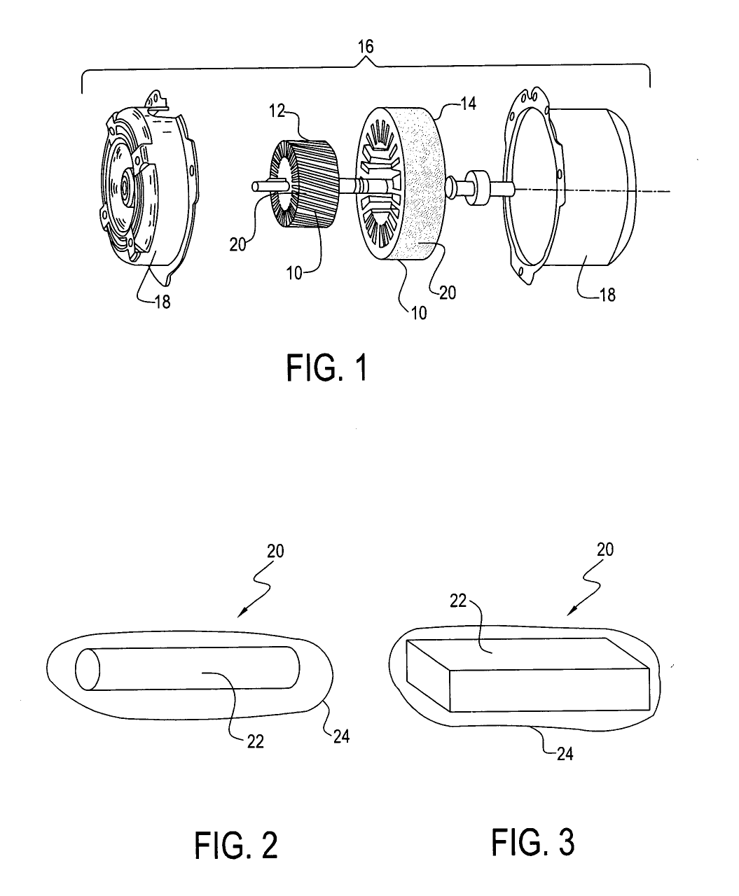

Referring now to the drawings and in particular to FIG. 1, exemplary embodiments of electromagnetic devices are illustrated generally by reference numeral 10. For purposes of clarity, electromagnetic devices 10 are illustrated as a rotor 12 and/or a stator 14 of an electric motor 16.

Motor 16 can include a housing 18 having rotor 12 and stator 14 disposed therein. In the illustrated example, stator 14 is the stationary portion of electric motor 16 that is mounted to and within housing 18. Rotor 12 is the rotating portion of motor 16 and is positioned for rotation within stator 14.

It should be recognized that electromagnetic device 10 is illustrated by way of example as rotor 12 and stator 14. Of course, it is contemplated by the present disclosure for electromagnetic device 10 to be any electromagnetic device such as, but not limited to, solenoids, transformer cores, inductors, actuators, MRI pole faces, MRI shims, sensors, electronic circuits, and others.

Electromagnetic devices 10 are formed of a plurality of particles 20 compacted together to a selected density. Thus, electromagnetic devices 10 are composite magnetic articles formed of compacted particles 20. Exemplary embodiments of particles 20 are illustrated in FIGS. 2 and 3. Each particle 20 includes a first portion 22 having a second portion 24 disposed thereon.

First portion 22 can be formed of any soft magnetic material such as, but not limited to, pure Fe, either in crystalline or amorphous form, or Fe alloys containing Fe, Ni, Co, Si, Al, B, P, C, Cr, Mn, and any combinations thereof. The choice of the specific material for first portion 22 can depend on the desired mechanical, electrical, and/or magnetic properties of electromagnetic devices 10.

Second portion 24 can be formed from any material sufficient to electrically insulate the plurality of first portions 22 from one another once particles 20 are compacted to form electromagnetic devices 10. For example, second portion 24 can be formed of a polymer, such as, but not limited to silicone, that encapsulates or substantially surrounds first portion 22.

It has been determined that the shape of first portion 22 can effect the magnetic properties exhibited by electromagnetic devices 10. Specifically, it has been found that electromagnetic devices 10 exhibit increased magnetic properties with particles 20 having an elongated shape as compared to, for example, spherical particles. For example, particle 20 can have an aspect ratio of between about 20 to about 500. As used herein, the term aspect ratio is defined as the ratio of the largest dimension of particle 20 to the smallest dimension of the particle. The cross section of particle 20 can be rectangular, polygonal, circular, oval, or any combination thereof.

Exemplary embodiments of particles 20 are illustrated in FIGS. 2 and 3. First portion 22 can have a rod-like shape having a length of about 0.1 inches to about 1.0 inches and a diameter of about 0.005 inches to about 0.0025 inches as illustrated in the embodiment of FIG. 2. In the embodiment of FIG. 3, first portion 22 has a flake-like shape with a length of about 0.1 inches to about 1.0 inches, a width of about 0.005 inches to about 0.0025 inches, and a height of about 0.001 inches to about 0.025 inches.

First portion 22 can be made from any known process such as slit sheet processes, drawn wire processes, and melt extract processes.

Electromagnetic devices 10 of the selected density can be formed using any known compaction process. Suitable compaction techniques include uniaxial compaction, isostatic compaction, injection molding, extrusion, hot isostatic pressing, electromagnetic compaction and others. In such processes, electromagnetic devices 10 can also include lubricants, binding agents, and other components in addition to particles 20. For example, second portion 24 can act as a binding agent for particles 20 in some embodiments of the present disclosure.

If desired, electromagnetic devices 10 can be annealed after compaction to remove the stresses introduced into first portion 22 during compaction, thereby achieving a higher magnetic permeability and a lower hysteresis loss. Magnetic permeability is the measure of the ease with which a material can be magnetized and indicates the ability of the material to carry magnetic flux.

It has been found that use of silicone as second portion 24 is particularly suited to allow electromagnetic device 10 to be formed through the aforementioned compaction and annealing processes. For example, second portion 24 of silicone is robust enough to mitigate damage to the coating during these compaction and annealing steps. Mitigation of damage to second portion 24 during formation of electromagnetic devices 10 mitigates eddy currents caused by electrical conductivity between individual first portions 22.

It has also been determined that the thickness and uniformity of second portion 24 can effect the magnetic properties exhibited by electromagnetic devices 10. For example, second portion 24 provides electrical insulation for first portions 22, which can reduce eddy current losses in electromagnetic device 10. However, the presence of excessive second portion 24 on first portion 22 reduces the magnetic permeability of electromagnetic devices 10. Accordingly, it has been found that second portion 24 disposed on each first portion 22 in a range from about 0.05 weight percent to about 1 weight percent balances these competing effects. In one embodiment, second portion 24 is disposed on first portion 22 in a range from about 0.1 weight percent to about 0.15 weight percent.

Advantageously, particle 20 having the aforementioned elongated first portion and thin, uniform second portion 24 is configured to provide electromagnetic devices 10 with a core loss of less than about 6 Watts per pound at a magnetic flux density of about 1 Tesla and a frequency of about 60 Hertz. In other embodiments, particle 20 is configured to provide electromagnetic devices 10 with a core loss of less than about 2.5 Watts per pound at a magnetic flux density of about 1 Tesla and a frequency of about 60 Hertz. Further, particle 20 having the aforementioned elongated first portion and thin, uniform second portion 24 provides electromagnetic devices 10 with a magnetic permeability of greater than about 1000 at a magnetic flux density of about 1 Tesla and a frequency of about 60 Hertz.

Thus, the elongated shape of particles 20 is particularly configured to provide electromagnetic devices 10 having minimal core losses and high permeability. However, it has been found that this elongated shape can be disadvantageous in applying second portion 24 to first portion 22 in the desired thickness and uniformity sufficient to achieve the aforementioned minimal core losses.

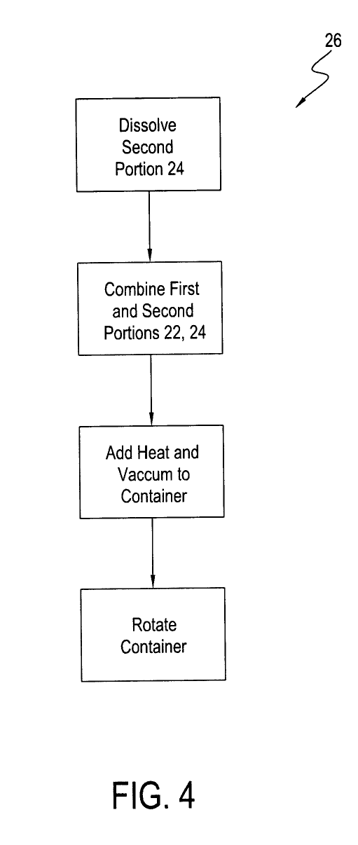

Referring now to FIG. 4, a first exemplary embodiment of a process 26 for applying second portion 24 to first portion 22 is illustrated. Process 26 can be a rotary vacuum process. During process 26, a selected amount of second portion 24 (e.g., a silicone) is dissolved in a solvent. Next, the dissolved second portion 24 and solvent are combined with first portion 22 in a round bottom container, such as a flask or drum. It should be recognized that first portion 22 can be added before, during, or after the dissolution of second portion 24 in the solvent.

It should also be recognized that the process 26 is described in the present disclosure having second portion 24 dissolved in a solvent. Of course, it is contemplated by the present disclosure for second portion 24 to merely be suspended in a carrier or for the second portion to be in liquid form.

The flask is then rotated at a desired speed, while being heated to about 90 to 95 degrees Celsius. A vacuum of about 170 mbar is applied to the container to drive away the solvent and, thus, leave first portion 22 coated with second portion 24. In one embodiment, silicone can be used as the polymer and xylene can be used as the solvent. It has been found that process 26 is particularly suited for production particles 20 having second portion 24 disposed on first portion 22 in the desired thickness and uniformity sufficient to achieve the aforementioned minimal core losses and high permeability in electromagnetic devices 10.

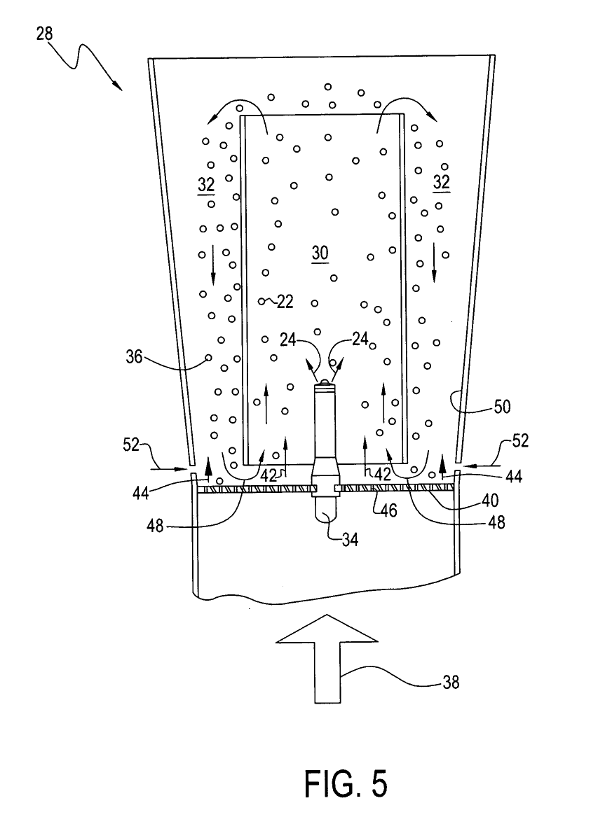

Referring now to FIG. 5, a second exemplary embodiment of a process 28 for applying second portion 24 to first portion 22 is illustrated. Process 28 is also particularly suited for production particles 20 having second portion 24 disposed on first portion 22 in the desired thickness and uniformity sufficient to achieve the aforementioned minimal core losses and high permeability in electromagnetic devices 10.

Process 28 includes an inner area 30, an outer area 32, a spray nozzle 34, a fluidized zone 36, a heated gas 38, and a gas distribution plate 40. Distribution plate 40 is configured to distribute a first flow 42 of heated gas 38 to inner area 30 and a second flow 44 of the heated gas to fluid zone 36. For reasons described in detail below, first flow 42 is a high velocity flow, while second flow 44 is a lower velocity flow. For example, plate 40 can include a plurality of diffusion holes 46 defined therein. Holes 46 in direct fluid communication with inner area 30 can be larger than the holes in direct fluid communication with fluidized zone 36 to provide the aforementioned first and second flows 42, 44.

The high velocity flow of first flow 42 separates the individual first portions 22 in inner area 30 from one another and transports the separated particles past spray nozzle 34. Spray nozzle 34 sprays solubilized and/or suspended second portion 24 on first portions 22 as they pass the nozzle. Second portion 24 can have a solvent vehicle that is aqueous, organic, or inorganic.

After passing through inner area 30, particles 20 (e.g., first and second portions 22, 24) enter outer area 32. Outer area 32 has an expanded area as compared to inner area 30, causing the velocity of first flow 42 to slow, which causes particles 20 to slow and, thus, fall back toward fluidized zone 36.

Second flow 44 has a sufficient velocity to maintain particles 20 in fluidized zone 36 a fluidized state to prevent agglomeration from occurring. First and second flows 42, 44 also aid in drying second portion 24 on first portions 22.

Particles 20 in fluid zone 36 near inner area 30 are drawn back into the high velocity of first flow 42 by a third or suction flow 48 and the cycle is repeated. Third flow 48 is believed to be generated by the effects of first flow 42 passing through inner area 30. In this manner, process 28 creates a circular flow of particles 20 that can be continued until a desired amount of second portion 24 is applied to first portions 22.

By way of example, it is contemplated by the present disclosure for process 28 to be carried out in a Wurster-type bottom coating apparatus as is commercially available from Glatt Air Techniques, Inc. of Ramsey, N.J. It should be recognized that process 28 is described above by way of example as having its inner and outer areas 30, 32 physically separated by a cylindrical tube. Of course, process 28 having a common or un-separated inner and outer area 30, 32 is contemplated by the present disclosure.

It has been found that the size, weight, and elongated shape of particles 20 can have deleterious effects on the desired circular flow of particles 20 in process 28. It has also been found that the size, weight, and elongated shape of particles 20 have deleterious effects on maintaining particles 20 in the desired fluidized state in fluidized area 36. For example, it has been observed that second flow 44 can be insufficient to fluidized particles 20 along outer walls 50 of outer area 32. Moreover, it has also been observed that third flow 48 can be insufficient to draw particles 20 back into inner area 30.

Advantageously, process 28 includes a fourth flow 52. Fourth flow 52 can aid second flow 44 in fluidizing particles 20 in fluidized area 36. In this manner, process 28 fluidizes particles 20 in fluidized area 36 in two directions, the direction of second flow 44 and the direction of fourth flow 52, which ensures that particles 20 along outer wall 50 are maintained in the desired circular flow of particles.

Further, fourth flow 52 can aid third flow 48 in forcing particles 20 back into inner area 30. In this manner, process 28 ensures that particles 20 have the desired circular flow through the process.

By way of example, process 28 can include fourth flow 52 having a direction that is substantially orthogonal or perpendicular to first flow 42 and/or second flow 44.

In one embodiment of process 28, fourth flow 52 is a resultant flow created by providing a plurality of openings 54 in outer wall 50. In this embodiment, first, second, and/or third flows 42, 44, 48 draw air into fluidized zone 36 through openings 54 to form the resultant fourth flow 52. Advantageously, merely allowing ambient air to be drawn into process 28 has been found sufficient to over-come the effects of the size, weight, and elongated shape of particles 20 to create the desired circular flow of the particles through the process.

In an alternate embodiment of process 28, fourth flow 52 is forced into fluidized zone 36. In this embodiment, fourth flow 52 is forced into process 28 with sufficient velocity to over come the effects of the size, weight, and elongated shape of particles 20 to create the desired circular flow of the particles through the process. In yet another embodiment, fourth flow 52 can be a combination of created flows and resultant flows.

Process 28 is configured to apply second portion 24 to first portion 22 where the size distribution of the first portions is in a range of about 1:10. In some embodiments, it is contemplated process 28 to apply second portion 24 to first portion 22 where the size distribution of the first portions is in a range of about 1:4. As used herein, the term size distribution is defined as the ratio of the size of the smallest first portion 22 in process 28 to the size of the largest first portion 22 in process 28.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present invention has been described with reference to one or more exemplary embodiments, it will be understood by those skilled in the art that various changes may be made and equivalents may be substituted for elements thereof without departing from the scope of the present invention. In addition, many modifications may be made to adapt a particular situation or material to the teachings of the disclosure without departing from the scope thereof. Therefore, it is intended that the present invention not be limited to the particular embodiment(s) disclosed as the best mode contemplated for carrying out this invention, but that the invention will include all embodiments falling within the scope of the appended claims.

1. A soft magnetic particle comprising:
an elongated first portion formed of a soft magnetic material; and
a second portion disposed on said first portion in an amount from about 0.05 weight percent to about 1 weight percent, said second portion being formed of an electrically insulating material.

2. The soft magnetic particle as in claim 1, wherein said amount is from about 0.1 weight percent to about 0.15 weight percent.

3. The soft magnetic particle as in claim 2, wherein said electrically insulating material comprises silicone.

4. The soft magnetic particle as in claim 1, wherein said soft magnetic material comprises Fe or an Fe alloy.

5. The soft magnetic particle as in claim 4, wherein said Fe alloy is selected from the group consisting of Co, Ni, Si, Al, B, P, C, Cr, Mn, and any combinations thereof.

6. The soft magnetic particle as in claim 1, wherein said first portion has an aspect ratio of between about 20 to about 500.

7. The soft magnetic particle as in claim 6, wherein said first portion has a cross-sectional shape selected from the group consisting of a rectangular shape, a polygonal shape, an oval shape, circular shape, and any combinations thereof.

8. A method of applying a coating to a plurality of elongated soft magnetic particles, the method comprising:
separating the plurality of elongated soft magnetic particles from one another with a first gas flow so that the coating can be applied to the plurality of elongated soft magnetic particles when separated;
fluidizing the plurality of elongated soft magnetic particles with a second gas flow after the plurality of elongated soft magnetic particles form a bed so that a third gas flow can urge the plurality of elongated soft magnetic particles in said bed back into said first gas flow; and
applying a fourth gas flow to said bed.

9. The method as in claim 8, wherein said fourth gas flow is sufficient to allow coating of particles having an aspect ratio of between about 20 to about 500.

10. The method as in claim 9, wherein said fourth gas flow is a forced gas flow, a resultant gas flow, or any combination thereof.

11. The method as in claim 10, wherein said fourth gas flow has a direction substantially orthogonal to said first gas flow.

12. The method as in claim 10, wherein said fourth gas flow aids said second gas flow in fluidizing the plurality of elongated soft magnetic particles.

13. The method as in claim 10, wherein said fourth gas flow aids said third gas flow in urging the plurality of elongated soft magnetic particles in said bed back into said first gas flow.

14. The method as in claim 8, further comprising repeating until the coating is applied to the plurality of elongated soft magnetic particles has a weight in a range from about 0.05 weight percent to about 1 weight percent.

15. The method as in claim 8, further comprising repeating until the coating is applied to the plurality of elongated soft magnetic particles has a weight in a range from about 0.1 weight percent to about 0.15 weight percent.

16. The method as in claim 8, wherein the plurality of elongated soft magnetic particles have a size distribution in a range of about 1:10.

17. The method as in claim 8, wherein the plurality of elongated soft magnetic particles have a size distribution in a range of about 1:4.

18. A composite magnetic article comprising a plurality of soft magnetic particles compacted to a selected density, each of said soft magnetic particles having an elongated first portion coated with an insulating second portion such that the composite magnetic article has a core loss of less than about 6 Watts per pound at a magnetic flux density of about 1 Tesla and a frequency of about 60 Hertz.

19. The composite magnetic article as in claim 18, wherein said core loss is less than about 2.5 Watts per pound at a magnetic flux density of about 1 Tesla and a frequency of about 60 Hertz.

20. The composite magnetic article as in claim 19, wherein said elongated first portion is coated with said insulating second portion such that the composite magnetic article has a magnetic permeability of greater than about 1000 at a magnetic flux density of about 1 Tesla and a frequency of about 60 Hertz.

21. The composite magnetic article as in claim 18, wherein said elongated first portion has an aspect ratio of between about 20 to about 500.

22. The composite magnetic article as in claim 18, wherein said insulating second portion has a weight in a range from about 0.05 weight percent to about 1 weight percent.

23. The composite magnetic article as in claim 18, wherein said insulating second portion has a weight in a range from about 0.1 weight percent to about 0.15 weight percent.

24. The composite magnetic article as in claim 18, wherein the composite magnetic article is an article selected from the group consisting of a stator, a rotor, a solenoid, a transformer core, an inductor, an actuator, an MRI pole face, an MRI shim, a sensors, and an electronic circuit.
